(19) United States
(12) Patent Application Publication
(10) Pub. No.: US 2016/0107265 A1
(43) Pub. Date: Apr. 21, 2016

(54) METHOD OF FUSION WELDING

(71) Applicant: ALCOA INC., Pittsburgh, PA (US)

(72) Inventors: Jen C. Lin, Export, PA (US); Israel Stol, Los Angeles, CA (US); Kyle L. Williams, Shelocta, PA (US); Xinyan Yan, Murrysville, PA (US); Philip E. Smith, Trafford, PA (US); Heather Drieling, Apollo, PA (US)

(21) Appl. No.: 14/884,382

(22) Filed: Oct. 15, 2015

Related U.S. Application Data
(60) Provisional application No. 62/064,256, filed on Oct. 15, 2014.

(51) Int. Cl. B23K 28/00; C22C 21/10; B23K 35/28

(52) U.S. Cl. CPC B23K 28/00; B23K 35/288; C22C 21/10; B23K 2203/10

(57) ABSTRACT

A method comprises fusion welding a filler metal to a first aluminum component; wherein the first aluminum component comprises a 7xxx series aluminum alloy; and wherein the filler metal comprises an aluminum alloy, in weight percent: up to 0.15 Fe; up to 0.15 Si; from 2.3 to 2.7 Mg; from 1.4 to 1.8 Cu; from 6.0 to 9.0 Zn; and from 0.06 to 0.14 Zr. In some embodiments, the 7xxx series aluminum alloy comprises 0.5-2.6 wt. % Cu. In some embodiments, the filler metal comprises, in weight percent, up to 0.45 Sc.

### CROSS REFERENCE TO RELATED APPLICATIONS

This application claims priority to U.S. Provisional Patent Application Ser. No. 62/064,256 filed Oct. 15, 2014, which is incorporated herein by reference in its entirety.

### BACKGROUND

7xxx series aluminum alloys offer significant potential advantages to several applications, which include: armored vehicles where high strength and blast resistance are very important, ship halls and other sub-structures, wing spares, mold-plates, and oil riser, to name a few. Common to all of these applications is the need to weld and/or repair parts together. Unlike some other heat treatable alloys (e.g. 6061, etc.) which can be welded to themselves and other alloys (e.g. 6061/5083), fusion welding certain 7xxx series alloys with or without addition of a filler alloy, without cracking in the welds and/or their adjoining fusion-zones and heat affected zones has been problematic.

### SUMMARY

A method comprises fusion welding a filler metal to a first aluminum component, wherein the first aluminum component comprises a 7xxx series aluminum alloy; and wherein the filler metal comprises (and in some instances consists essentially of) an aluminum alloy, in weight percent: up to 0.15 Fe; up to 0.15 Si; from 2.3 to 2.7 Mg; from 1.4 to 1.8 Cu; from 6.0 to 9.0 Zn; and from 0.06 to 0.14 Zr, in some instances, the balance essentially aluminum and incidental elements and impurities.

In another embodiment, a method comprises: abutting a first aluminum component against a second aluminum component, wherein an abutment is formed, and fusion welding a filler metal to the first aluminum component and to the second aluminum component so that a welded joint is formed at the abutment; wherein the first aluminum component comprises a 7xxx series alloy; and wherein the filler metal is an aluminum alloy comprising, (and in some instances consists essentially of) in weight percent: up to 0.15 Fe; up to 0.15 Si; from 2.3 to 2.7 Mg; from 1.4 to 1.8 Cu; from 6.0 to 9.0 Zn; and from 0.06 to 0.14 Zr, in some instances, the balance essentially aluminum and incidental elements and impurities.

In a further embodiment, a method comprises: locating a surface defect of a mold block and repairing the surface defect; wherein the surface defect has a first volume, wherein the surface defect is at least partially surrounded by an original volume, wherein the mold block includes the original volume, wherein the mold block is made of a 7xxx series aluminum alloy, wherein the repairing comprises fusion welding a filler metal to at least a portion of the original volume to produce a repaired volume, wherein the repaired volume includes the first volume of the surface defect and at least a portion of the original volume; and wherein the filler metal is an aluminum alloy comprising, (and in some instances consists essentially of) in weight percent: up to 0.15 Fe; up to 0.15 Si; from 2.3 to 2.7 Mg; from 1.4 to 1.8 Cu; from 6.0 to 9.0 Zn; and from 0.06 to 0.14 Zr, in some instances, the balance essentially aluminum and incidental elements and impurities.

In yet another embodiment, a method comprises: fusion welding a weld filler metal to a first aluminum component, wherein the first aluminum component comprises one of; a AA 6xxx alloy and a 5xxx; and wherein the filler metal comprises an aluminum alloy, (and in some instances consists essentially of) in weight percent: up to 0.15 Fe; up to 0.15 Si; from 2.3 to 2.7 Mg; from 1.4 to 1.8 Cu; from 6.0 to 9.0 Zn; and from 0.06 to 0.14 Zr, in some instances, the balance essentially aluminum and incidental elements and impurities.

A product comprises a first aluminum component having a weld, the weld containing filler metal, wherein the first aluminum component comprises a 7xxx series aluminum alloy; and wherein the filler metal comprises (and in some instances consists essentially of) an aluminum alloy, in weight percent: up to 0.15 Fe; up to 0.15 Si; from 2.3 to 2.7 Mg; from 1.4 to 1.8 Cu; from 6.0 to 9.0 Zn; and from 0.06 to 0.14 Zr, in some instances, the balance essentially aluminum and incidental elements and impurities, wherein the weld is defect-free or substantially defect-free.

Another product comprises embodiment, a first aluminum component attached to a second aluminum component via a weld, wherein the weld contains a filler metal, wherein the first aluminum component comprises a 7xxx series alloy; and wherein the filler metal is an aluminum alloy comprising, (and in some instances consists essentially of) in weight percent: up to 0.15 Fe; up to 0.15 Si; from 2.3 to 2.7 Mg; from 1.4 to 1.8 Cu; from 6.0 to 9.0 Zn; and from 0.06 to 0.14 Zr, in some instances, the balance essentially aluminum and incidental elements and impurities, wherein the weld is defect-free or substantially defect-free.

Yet another product comprises a mold block having a repaired portion, wherein the repaired portion comprises a weld, wherein the weld contains filler metal, wherein the mold block is made of a 7xxx series aluminum alloy, wherein the filler metal is an aluminum alloy comprising, (and in some instances consists essentially of) in weight percent: up to 0.15 Fe; up to 0.15 Si; from 2.3 to 2.7 Mg; from 1.4 to 1.8 Cu; from 6.0 to 9.0 Zn; and from 0.06 to 0.14 Zr, in some instances, the balance essentially aluminum and incidental elements and impurities, wherein the repaired portion is defect-free or substantially defect-free.

The following features can be combined with any of the embodiments above, as applicable.

In some embodiments, the filler metal consists essentially of, in weight percent: up to 0.15 Fe; up to 0.15 Si; from 2.3 to 2.7 Mg; from 1.4 to 1.8 Cu; from 6.0 to 9.0 Zn; from 0.06 to 0.14 Zr; and optionally, up to 0.45 Sc, the remainder being aluminum, incidental elements and impurities.

In some embodiments, the filler metal comprises, in weight percent, up to 0.45 Sc. In some embodiments, the filler metal comprises, in weight percent, 0.25-0.35 Sc.

In some embodiments, the filler metal comprises, in weight percent, up to 0.10 Fe.

In some embodiments, the filler metal comprises, in weight percent, up to 0.10 Si.

In some embodiments, the filler metal comprises, in weight percent, 7.3 to 7.7 Zn.

In some embodiments, the filler metal comprises, in weight percent, 0.10 to 0.12 Zr.

In some embodiments, the filler metal comprises, in weight percent, up to 0.03 B. In some embodiments, the filler metal comprises, in weight percent, 0.015 to 0.025 B.

In some embodiments, the 7xxx series aluminum alloy comprises 0.5-2.6 wt. % Cu.

In some embodiments, the 7xxx series aluminum alloy comprises 0.08-0.6 wt. % Fe.

In some embodiments, the 7xxx series aluminum alloy comprises 0.06-0.50 wt % Si.

In some embodiments, the 7xxx series aluminum alloy comprises up to 0.50 wt % Mn.

In some embodiments, the 7xxx series alloy comprises up to 0.35 wt % Cr.

In some embodiments, the 7xxx series alloy comprises, in weight percent: up to 0.06 Si; up to 0.08 Fe; 1.3 to 2.0 Cu; up to 0.04 Mn; 1.2 to 1.8 Mg; up to 0.04 Cr; 7.0 to 8.0 Zn; up to 0.15 Ti; and 0.08 to 00.15 Zr.

In some embodiments, the 7xxx series alloy comprises, in weight percent: up to 0.06 Si; up to 0.08 Fe; 1.5 to 1.7 Cu; 1.4 to 1.6 Mg; 7.2 to 7.8 Zn; up to 0.15 Ti; and 0.09 to 00.13 Zr.

In some embodiments, the 7xxx series alloy comprises one of: 7x09, 7x10, 7x12, 7x14, 7x16, 7x20, 7x21, 7x22, 7x23, 7x24, 7x25, 7x26, 7x28, 7x29, 7x30, 7x32, 7x33, 7x34, 7x35, 7x36, 7x37, 7x40, 7x41, 7x42, 7046, 7x49, 7x50, 7x55, 7x56, 7x60, 7x64, 7x65, 7x68, 7x75, 7x76, 7x78, 7x79, 7x81, 7x85, 7x90, 7x93, 7x95 and 7x99 as defined by the Aluminum Association Teal Sheets, entitled, “International Alloy Designations and Chemical Composition Limits for Wrought Aluminum and Wrought Aluminum Alloys” as revised January 2015, which is incorporated by reference herein. For instance, a 7x55 alloy may be a 7055, 7155, or 7255 alloy, or a future other versions thereof.

In some embodiments, the 7xxx series alloy comprises one of: 7x09, 7x10, 7x12, 7x14, 7x16, 7x22, 7x23, 7x24, 7x25, 7x26, 7x29, 7x32, 7x33, 7x34, 7x36, 7x37, 7x40, 7x41, 7x42, 7x49, 7x50, 7x55, 7x56, 7x60, 7x64, 7x65, 7x68, 7x75, 7x76, 7x78, 7x79, 7x81, 7x85, 7x90, 7x93, 7x95 and 7x99 as defined by the Aluminum Association Teal Sheets, entitled, “International Alloy Designations and Chemical Composition Limits for Wrought Aluminum and Wrought Aluminum Alloys” as revised January 2015.

In some embodiments, the second aluminum component comprises a 7xxx aluminum alloy. In some embodiments, the first aluminum component and the second aluminum component each comprise at least 0.5 wt. % Cu. In some embodiments, the second aluminum component comprises one of the 7xxx series aluminum alloys listed above.

In some embodiments, the welded joint is one of a: butt, corner, edge, lap, and tee.

In some embodiments, fusion welding comprises one of: gas metal arc welding, gas tungsten arc welding, laser beam welding, electron beam welding, and plasma welding. In some embodiments, welding is performed on a joint. In some embodiments, welding is performed on one of: a lap-fillet joint, a square butt joint, a vee butt joint, and a tee-fillet joint.

In some embodiments, filler metal alloys disclosed herein are used in additive manufacturing.

The alloys of the present disclosure generally include the stated alloying ingredients, the balance being aluminum, optional grain structure control elements, optional incidental elements and impurities.

### BRIEF DESCRIPTION OF THE DRAWINGS

FIG. 1 is a flow chart illustrating one embodiment of a method useful in accordance with the present disclosure.

FIG. 2 is a flow chart illustrating another embodiment of a method useful in accordance with the present disclosure.

FIG. 3 is a schematic view of one embodiment of a 7xxx mold plate having a surface defect.

FIG. 4 is a schematic view of one embodiment of a 7xxx mold plate having a repaired volume.

FIG. 5 shows etched and anodized cross-sectional micrographs of a weldment produced with standard AA7085 base metal and 5356 filler wire.

FIG. 6a is a photograph of a weldment produced by manually GTA welding two 0.5 in thick standard AA7085 plates with the AA5356 filler alloy.

FIG. 6b shows the weldment of FIG. 6a inspected with dye penetrant.

FIG. 7 is a graph showing the solidification analysis of the AA5356 filler alloy for fusion welding AA7085 parts.

FIG. 8 is a graph showing the solidification analysis of the AA4043 filler alloy for fusion welding AA7085 parts.

FIG. 9 is a graph showing the solidification analysis with a new filler alloy #266 from Table 3.

FIG. 10 shows a typical cross-sectional macrograph through a GTAW Tee-Double Fillet Weldment, used to assess the fusion weldability of different weld filler alloys for welding AA 7085 parts.

FIG. 11 includes three photographs of a weld of AA7085 base metal with filler alloy #263 from Table 3.

FIG. 12 includes three photographs of a weld of AA7085 base metal with filler alloy #264 from Table 3.

FIG. 13 includes three photographs of a weld of AA7085 base metal with tiller alloy #265 from Table 3.

FIG. 14 includes three photographs of a weld of AA7085 base metal with filler alloy #266 from Table 3.

FIG. 15 is a comparison of cross-sectional optical micrographs.

FIG. 16 includes two photographs of a weld of AA7085 base metal with filler alloy #266 from Table 3 (shown on left) and filler alloy #263 from Table 3 (shown on right).

### DESCRIPTION

It will be appreciated by those of ordinary skill in the art that welding using the disclosed methods, systems and apparatus can be embodied in other specific forms without departing from the spirit or essential character thereof. The presently disclosed embodiments are therefore considered in all respects to be illustrative and not restrictive. Reference is now made to the accompanying drawings, which at least assist in illustrating various pertinent features of the disclosure.

In some embodiments, the filler alloy enables weld fabrication and repair of structures (e.g. armored vehicles, risers and oil platforms, ship halls, etc.), with fusion based welding processes such as manual gas metal arc welding and gas tungsten arc welding processes.

In some embodiments, the filler alloy affords significant opportunities for re-design of structures (e.g. armor plates, etc.) that are lighter and less expensive, through the use of the stronger and tougher parts (e.g. plates) made of the 7085 aluminum alloy or other 7xxx series aluminum alloys, including 7xxx aluminum alloys that contain 0.5-2.6 wt % Cu, that can be fusion welded with embodiments of the filler alloy.

In some embodiments, the filler alloy enables fusion welding to AA 7085 or other 7xxx series aluminum alloys, including 7xxx aluminum alloys that contain 0.5-2.6 wt % Cu. In some embodiments, the filler alloy has a composition that yields weld deposits (a mixture of filler alloy and base metal) having a solidus temperature lower than the solidus temperature of AA7085, or other 7xxx series aluminum alloys, including 7xxx aluminum alloys that contain 0.5-2.6 wt % Cu, at any Liquid/Solid fraction in the welds. By having the welds always solidify after the partially molten AA7085, or other 7xxx series aluminum alloys, including 7xxx aluminum alloys that contain 0.5-16 wt % Cu, solidifies hot-cracking in the fusion and heat affected zones adjoining the welds and liquation cracking in the welds will be prevented. Additionally, the weld deposits have resistance to hot cracking during solidification.

Some embodiments of the filler alloy contain grain refiner(s) that minimize the size of the grains. The resultant finer weld microstructures minimize the propensity to liquation cracking and weld cracking in the bulk of these welds and regions just next to the fusion zones.

In some embodiments, the filler alloy has very good hot cracking resistance, and upon melting and mixing with the AA7085, or other 7xxx series aluminum alloys, including 7xxx aluminum alloys that contain 0.5-2.6 wt % Cu, base metals, yields weld deposits whose solidus temperatures are always lower than the solidus temperatures of AA7085, or other 7xxx series aluminum alloys, including 7xxx aluminum alloys that contain 0.5-2.6 wt % Cu, at any Liquid/Solid fraction in the welds. By having the welds always solidify after the partially molten AA7085, or other 7xxx series aluminum alloys, including 7xxx aluminum alloys that contain 0.5-2.6 wt % Cu, solidifies in the fusion zones and adjoining HAZ's, hot-cracking in the fusion and HAZ's adjoining the welds and liquation cracking in the welds, especially next to the fusion zone, will be prevented from occurring in these regions of the weldments.

In some embodiments, the filler alloy contains titanium diboride (TiB2) and 0.3% of scandium (Sc) grain refiners that additively minimize the size of the grains. The resultant finer weld microstructures minimize the propensity to liquation cracking in the bulk of these welds and regions just next to the fusion zones. To compensate for the losses of these grain refiners as the welding filler alloy melts and the molten droplets detach from the tip of the wire and are transported through the arc when welding with the Gas Tungsten Metal Arc (GTAW) and Gas Metal Arc Welding (GMAW) processes, extra amounts of these two grain refiners can be added to the filler alloy.

The terms “filler alloy” and “filler metal” are used interchangeably herein.

Fusion welding means to join at least two portions together such as by one or more of heating, melting, fusing and metallurgically coalescing, and combinations thereof, such as with the assistance of a weld filler alloy. Examples of some types of welding processes include GTAW, shielded metal arc welding (SMAW), GMAW, plasma arc welding (PAW) and laser beam welding (LBW), to name a few.

As used herein, “grain structure control element” means elements or compounds that are deliberate alloying additions with the goal of forming second phase particles, usually in the solid state, to control solid state grain structure changes during thermal processes, such as recovery and recrystallization. Examples of grain structure control elements include Zr, Sc, V, Cr, Mn, and Hf, to name a few.

The amount of grain structure control material utilized in an alloy is generally dependent on the type of material utilized for grain structure control and the alloy production process. When zirconium (Zr) is included in the alloy, it may be included in an amount up to about 0.4 wt. %, or up to about 0.3 wt. %, or up to about 0.2 wt. %. In some embodiments, Zr is included in the alloy in an amount of from about 0.05 wt. % to about 0.15 wt. % (e.g., from about 0.08 wt. % to about 0.13 wt. %). Scandium (Sc), vanadium (V), chromium (Cr), Manganese (Mn) and/or hafnium (Hf) may be included in the alloy as a substitute (in whole or in part) for Zr, and thus may be included in the alloy in the same or similar amounts as Zr. In some embodiments, no grain structure control elements are used, such as when there is no inherent need to control, for example, recrystallization.

As used herein, “incidental elements” means those elements or materials that may optionally be added to the alloy to assist in the production of the alloy. Examples of incidental elements include casting aids, such as grain refiners and deoxidizers.

Grain refiners are inoculants or nuclei to seed new grains during solidification of the alloy. An example of a grain refiner is a 9.5 mm (⅜ inch) rod comprising 96% aluminum, 3% titanium (Ti) and 1% boron (B), where virtually all boron is present as finely dispersed TiB2 particles. During casting, the grain refining rod is fed in-line into the molten alloy flowing into the casting pit at a controlled rate. The amount of grain refiner included in the alloy is generally dependent on the type of material utilized for grain refining and the alloy production process. Examples of grain refiners include Ti combined with B (e.g., TiB2) or carbon (TiC), although other grain refiners, such as Al—Ti master alloys may be utilized. Generally, grain refiners (e.g., carbon or boron) may be added to the alloy in an amount of ranging from 0.0003 wt. % to 0.03 wt. %, depending on the desired as-cast grain size. In addition, Ti may be separately added to the alloy in an amount up to 0.03 wt. % to increase the effectiveness of grain refiner. When Ti is included in the alloy, it is generally present in an amount of up to about 0.10 or 0.20 wt. %.

Some alloying elements, generally referred to herein as deoxidizers (irrespective of whether the actually deoxidize), may be added to the alloy during casting to reduce or restrict (and is some instances eliminate) cracking of the ingot resulting from, for example, oxide fold, pit and oxide patches. Examples of deoxidizers include Ca, Sr, and Be. When calcium (Ca) is included in the alloy, it is generally present in an amount of up to about 0.05 wt. %, or up to about 0.03 wt. %. In some embodiments, Ca is included in the alloy in an amount of from about 0.001 wt. % to about 0.03 wt. %, or from about 0.001 wt. % to about 0.05 wt. %, or from about 0.001 wt. % to about 0.008 wt. % (or from about 10 ppm to about 80 ppm). Strontium (Sr) may be included in the alloy as a substitute for Ca (in whole or in part), and thus may be included in the alloy in the same or similar amounts as Ca. Traditionally, beryllium (Be) additions have helped to reduce the tendency of ingot cracking, though for environmental, health and safety reasons, some embodiments of the alloy are substantially Be-free. When Be is included in the alloy, it is generally present in an amount of up to about 20 ppm.

Incidental elements may be present in minor amounts, or may be present in significant amounts, and may add desirable or other characteristics on their own without departing from the alloy described herein, so long as the alloy retains the desirable characteristics described herein. It is to be understood, however, that the scope of this disclosure should not/cannot be avoided through the mere addition of an element or elements in quantities that would not otherwise impact on the combinations of properties desired and attained herein.

As used herein, impurities are those materials that may be present in the alloy in minor amounts due to, for example, the inherent properties of aluminum and/or leaching from contact with manufacturing equipment. Iron (Fe) and silicon (Si) are examples of impurities generally present in aluminum alloys. The Fe content of the alloy should generally not exceed about 0.25 wt. %. In some embodiments, the Fe content of the alloy is not greater than about 0.15 wt. %, or not greater than about 0.10 wt. %, or not greater than about 0.08 wt. %, or not greater than about 0.05 wt. % or about 0.04 wt. %. Likewise, the Si content of the alloy should generally not exceed about 0.25 wt. %, and is generally less than the Fe content. In some embodiments, the Si content of the alloy is not greater than about 0.12 wt. %, or not greater than about 0.10 wt. %, or not greater than about 0.06 wt. %, or not greater than about 0.03 wt. % or about 0.02 wt. %.

Except where stated otherwise, the expression “up to” when referring to the amount of an element means that that elemental composition is optional or incidental and includes a zero amount of that particular compositional component. Unless stated otherwise, all compositional percentages are in weight percent (wt. %).

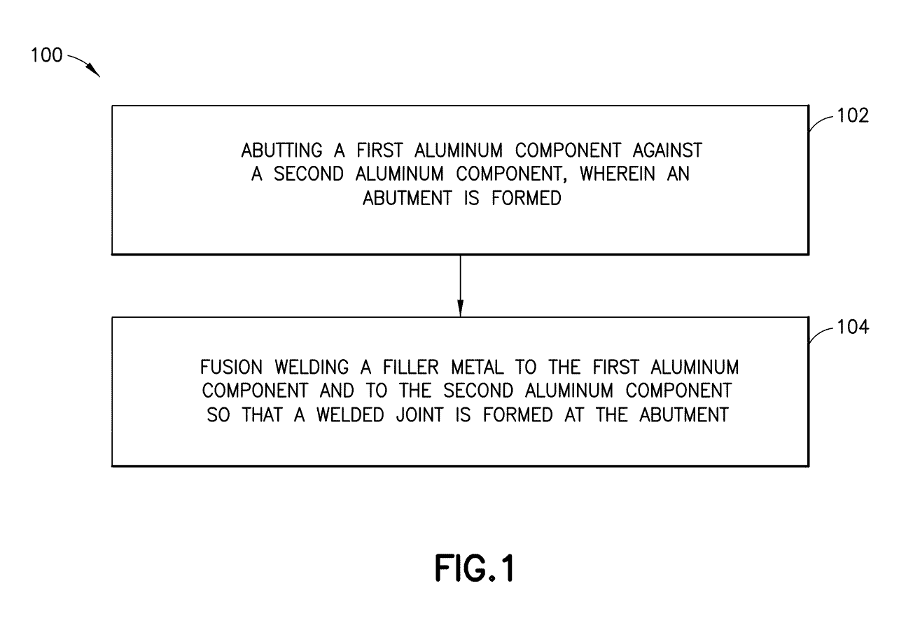

One embodiment useful in accordance with the present disclosure is illustrated in FIG. 1 The method 100 includes abutting a first aluminum component against a second aluminum component 102 and wherein an abutment is formed and fusion welding a filler metal to the first aluminum component and to the second aluminum component so that a welded joint is formed at the abutment 104; wherein the first aluminum component comprises a 7xxx series alloy; and wherein the filler metal is an aluminum alloy comprising, in weight percent: up to 0.15 Fe; up to 0.15 Si; from 2.3 to 2.7 Mg; from 1.4 to 1.8 Cu; from 6.0 to 9.0 Zn; and from 0.06 to 0.14 Zr.

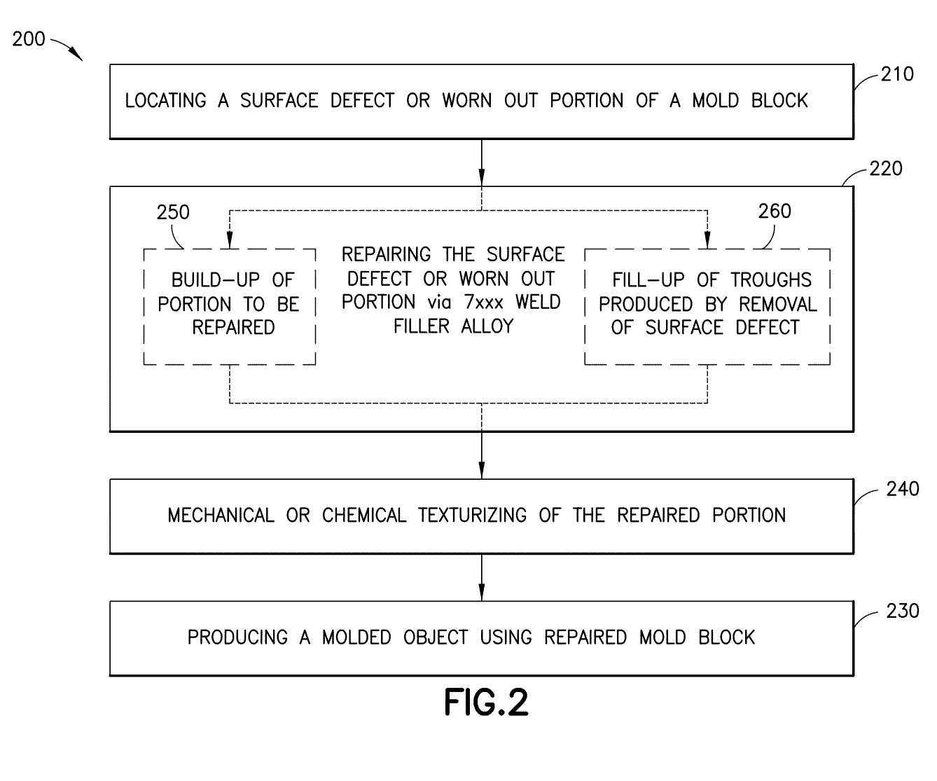

A second embodiment useful in accordance with the present disclosure is illustrated in FIG. 2. The method 200 includes locating a surface defect or worn out portion of a mold block 210, and repairing the surface defect or worn out portion via a weld filler alloy 220. Prior to the repairing step 220, the surface defect (or worn out portion) has a first volume, which is at least partially surrounded by an original volume. The mold block includes the original volume, and is made of a wrought 7xxx aluminum alloy. The repairing step 220 may include fusion welding the weld filler alloy to at least a portion of the non-defective volume to produce a repaired volume, wherein the weld filler alloy comprises (and in some instances consists essentially of) an aluminum alloy, in weight percent: up to 0.15 Fe; up to 0.15 Si; from 2.3 to 2.7 Mg; from 1.4 to 1.8 Cu; from 6.0 to 9.0 Zn; and from 0.06 to 0.14 Zr. In another embodiment, the repairing step 220 includes patch welding. Patch welding is welding in a localized area for the purpose of repair of a damages area (e.g., crack(s), worn down areas), and which has the appearance of a patch.

In one embodiment, the repairing step 220 includes repairing the surface defect or worn out portion by a build-up step 250. For example, the repairing step 220 includes building-up 250 the repaired portion to a height that is higher than that of the outer surface of the 7xxx alloy product. This may be useful, for example, for rebuilding worn out portions of the mold plate or imparting new geometric features to improve the control over the flow of the injected plastic or add new functional features, in order to form the injected parts into the desired final shape.

In another embodiment, the repairing step 220 includes filling troughs by removing the surface defects 260. For example, the repairing step 220 includes trough filling 260 the defective area to its original shape by depositing a 7xxx weld deposit on top and adjacent of the trough or surface defect. This may be useful, for example, for repairing damaged portions of the mold plate to improve the control over the flow of the injected plastic in order to produce injected plastic parts with the desired final shape similar to injected plastic parts produced with an undamaged mold plate.

After the repairing step 220, whether by build-up 250 or fill-up 260, the repaired volume may include the first volume of the surface defect and at least a portion of the original mold plate adjacent to the original defective volume diluted into and mixed with the molten filler alloy that filled and replaced the defective volume into the repaired one.

In one embodiment, after the repairing step 220, the repaired portion of the 7xxx alloy product may be optionally texturized in a texturizing step 240. In some instances, the texturizing step 240 may be accomplished by mechanical denting, chemical etching or a combination of the two. In some embodiments, texturizing a repaired mold plate may improve injection molding productivity with the mold plate having a longer lifetime (e.g., can be used longer, can last longer).

FIG. 3, shows a 7xxx mold plate 300 having features suited for the production of mold parts. A surface defect 302 of a 7xxx mold plate 300 may be produced via normal production operations. This surface defect (sometimes called a discontinuity) may be repaired with the weld filler alloys disclosed herein to produce repaired 7xxx mold plates.

A surface defect, is a defect on the surface of the 7xxx alloy product that inhibits or prevents the use of the 7xxx alloy product in its intended environment. Examples of surface defects 302 that generally occur in 7xxx mold plates 300 include cracks open to the surface and/or worn out portions of the mold plate 300. Generally, a surface defect 302 has a depth of not greater than about 6.4 mm (0.25 inch), but in some instances has a depth greater than about 6.4 mm (0.25 inch). In one embodiment, the surface defect 302 has a depth in the range of from about 0.025 mm (0.001 inch) to about 3.2 mm (0.125 inch).

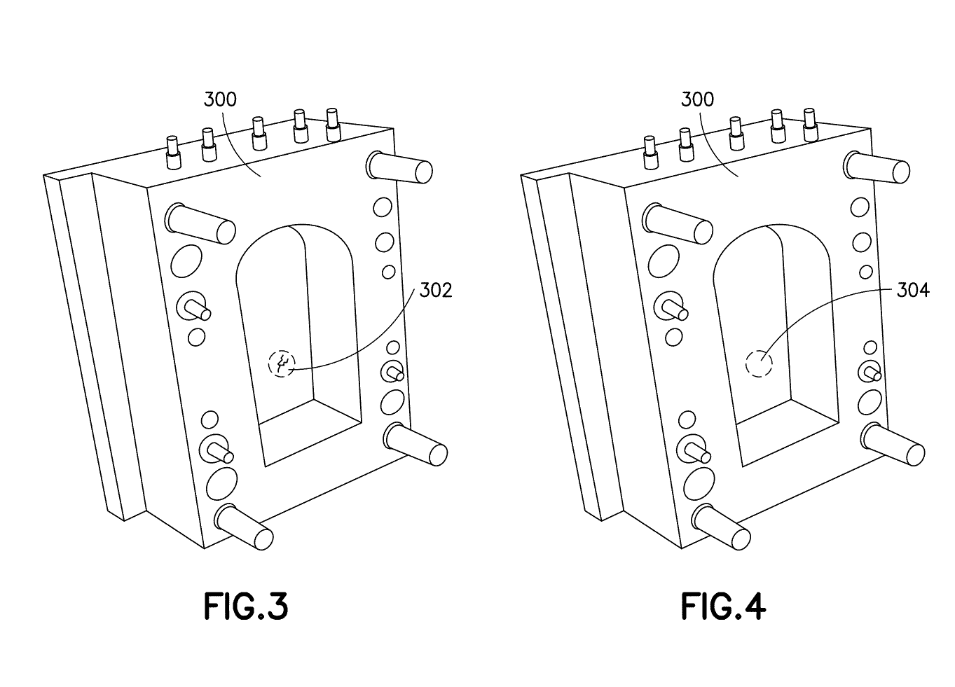

A mold plate (sometimes called a mold block) is a plate that is used to mold parts, with processes such as injection molding or blow molding. As illustrated in FIG. 4, the repaired portion 304 of the repaired 7xxx mold plates 300 is intended to facilitate substantially the same appearance (e.g., texture, color match) and function (e.g., thermo-mechanical, abrasion resistance) on the applicable outer surface of products produced with the 7xxx mold plate 300, which may facilitate the reuse of the repaired 7xxx mold plates 300. The repaired 7xxx mold plates 300 may also realize enhanced functional characteristics (e.g., durability, strength), which may also facilitate the reuse of the repaired 7xxx mold plates 300. In the end, the lifetime of the 7xxx mold plates 300 may be substantially increased via use of the new 7xxx based weld filler alloys.

The new 7xxx weld filler alloys disclosed herein are 7xxx aluminum alloys in the form of a weld filler alloy produced in the form of a rod for manual GTAW or continuous wire for welding with the gas metal arc welding (GMAW) process. A weld filler alloy is an alloy that is used to weld or repair an aluminum alloy product. Examples of weld filler alloys forms include weld rods, weld wires and powders that can be clad over a repair area (e.g., with the aid of a laser beam welding process). Other weld filler alloy forms may be used.

7xxx series aluminum alloys are aluminum alloys comprising Zn as a primary alloying constituent. 7xxx aluminum alloys may also include one or more of Cu, Mg and Mn, among others elements, as alloying constituents. Some examples of 7xxx aluminum alloys include any of the 7xxx series alloys defined by the Aluminum Association, including Al—Zn—Mg, Al—Zn—Cu, Al—Zn—Cu—Mg and other similar alloys.

The alloys and tempers mentioned herein are as defined by the American National Standard Alloy and Temper Designation System for Aluminum ANSI H35.1 and the Aluminum Association International Alloy Designations and Chemical Composition Limits for Wrought Aluminum and Wrought Aluminum Alloys as revised January 2015, which are incorporated by reference herein.

### EXAMPLE 1

TABLE 1
Compositional Limits of one embodiment of a new filler alloy

| Alloy # 266 | Fe | Si | Mg | Cu | Zn | Zr | Sc | B* | Ti |
|---|---|---|---|---|---|---|---|---|---|
| Target | | | 2.5 | 1.6 | 7.5 | 0.11 | 0.3 | 0.02 | 0.06 |
| Upper | 0.1 | 0.1 | 2.7 | 1.8 | 7.7 | 0.12 | 0.35 | 0.025 | 0.09 |
| Limit | | | | | | | | | |
| Lower | | | 2.3 | 1.4 | 7.3 | 0.1 | 0.25 | 0.015 | |
| Limit | | | | | | | | | |

*add 3:1 TiBor to B level to 0.02 wt %

TABLE 2
Composition of AA 7085 as used in this example

Si <0.06% by weight
Fe <0.08% by weight
Cu - 1.6% (1.5-1.7) % by weight
Mg - 1.5 (1.4-1.6) % by weight
Zn - 7.5 (7.2-7.8) % by weight
Zr - 0.11 (0.09-0.13) % by weight
Ca <0.0012% by weight
Ti <0.06% by weight

TABLE 3
Compositions of the four candidate filler alloys for fusion welding
AA 7085 that were cast into book-molds. The Boron levels listed in
the table are before TiBor was added.

| Filler | | | | | | | | | |
|---|---|---|---|---|---|---|---|---|---|
| Alloy | Fe | Si | Mg | Cu | Zn | Zr | Sc | B* | Ti |
| #263 | 0.073 | 0.058 | 5.14 | 0.003 | 2.97 | 0.059 | 0 | 0.012 | 0.052 |
| #264 | 0.075 | 0.063 | 5.06 | 0.001 | 2.86 | 0.1 | 0.3 | 0.015 | 0.049 |
| #265 | 0.08 | 0.058 | 2.5 | 1.63 | 7.4 | 0.069 | 0.001 | 0.016 | 0.054 |
| #266 | 0.085 | 0.064 | 2.49 | 1.58 | 7.35 | 0.1 | 0.31 | 0.014 | 0.048 |

Four book molds were cast, where each of the book molds consisted of one of the four candidate alloys in Table 3. Each of the book molds measured 2.25 in×3.75 in×14 in. The ingots were cropped, scalped and homogenized for hot rolling into 0.5 in thick plates, out of which welding rods were sawed off for the weldability evaluations with the manual GTA welding process.

The weldability tests with the different welding filler alloys were carried out with the following manual GTA welding conditions:
Process: GTAW-AC Current
Electrode Diameter: 0.187″ diameter Zirconia tungsten
Gas Cup: 0.625″ diameter
Shielding Gas: 75% Argon/25% Helium
Shielding Gas Flow Rate: 40 CFH
Weld Filler Wire Fabrication: Cast and rolled to 0.5″ book molds sawn into approximately 0.187″ squares, cleaned in A31K alkaline cleaner, rinsed, dried overnight, solvent wiped with acetone and abraded with stainless steel mesh and solvent wiped with acetone.
Base Metal Fabrication: Parts machined from 1.0″ thickness to 0.5″ thickness at t/2, saw cut bevel to a 37.5 degree angle solvent wiped with acetone, edges filed and stainless steel wire brushed.
Weld joint: Single vee butt joint 12″ long, welded parallel to the plate rolling direction, 75 degree included angle, 0.03″ root face, 0.093″-0.125″ root opening. Anodized aluminum backing bar with a 0.375″ wide×0.04″ groove centered along the weld seam used.
Weld passes: 4
Interpass Operations: Interpass temp of 120 degrees F. or below maintained between passes, each weld pass stainless steel wire brushed.

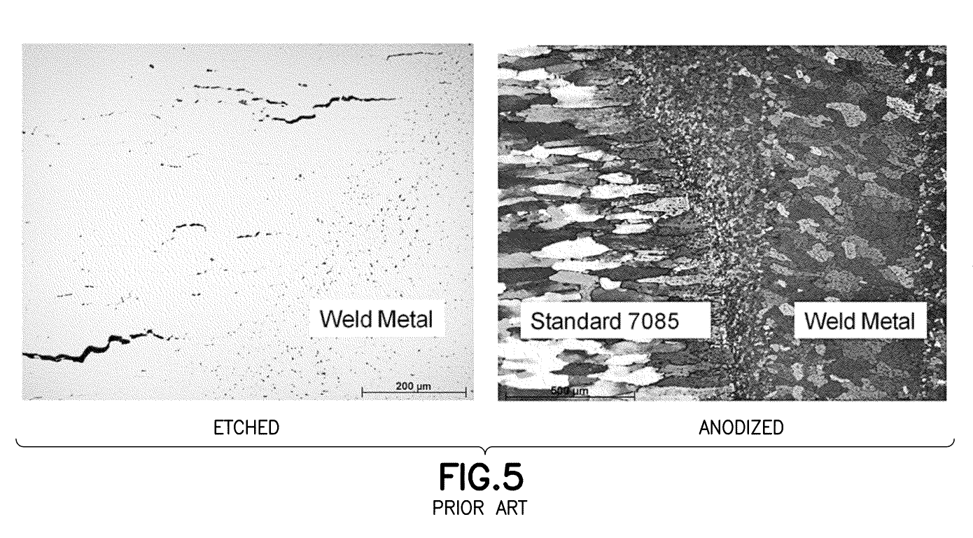

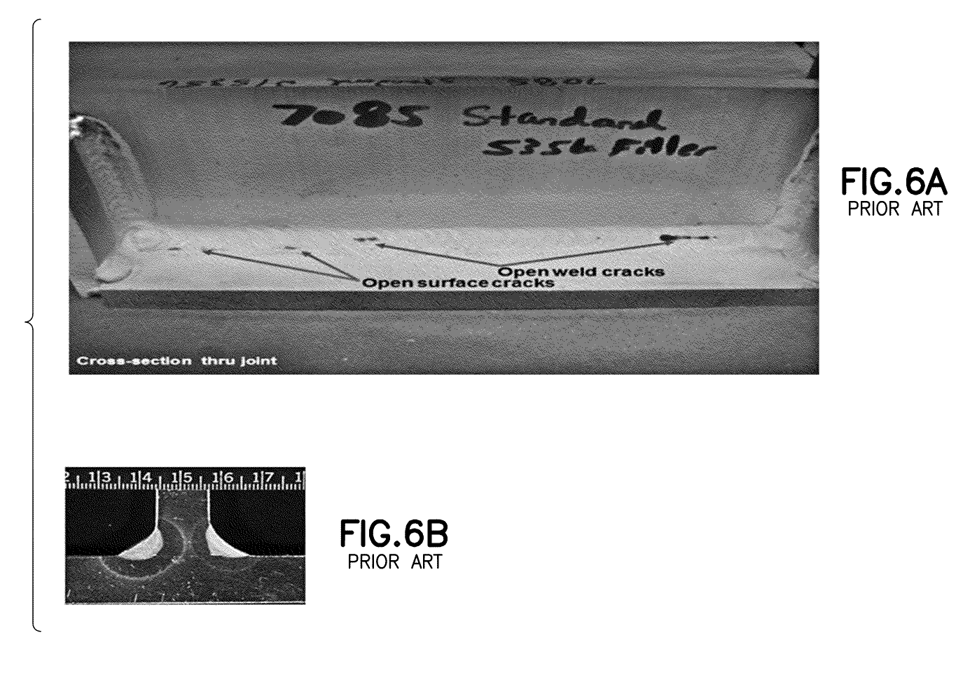

FIG. 5 shows etched and anodized cross-sectional micrographs of a weldment produced with standard AA7085 base metal and 5356 filler wire. The cross-section was of a weld produced by manual GTA welding an end constrained Double-Tee-Fillet type joint as shown in FIG. 6. Note: The coarse grains in the standard 7085 part (left) and weld and hot-cracks along the grain boundaries in the 7085 base metal (left) about the fusion and HAZ zones shown in FIG. 6.

FIG. 6a is a photograph of a weldment produced by manually GTA welding two 0.5 in thick standard AA7085 plates with the AA5356 filler alloy. FIG. 6b shows the weldment of FIG. 6a inspected with Dye Penetrant. A representative macro-graph taken from this weldment. The Dye penetrant test reveals open surface cracks in the 7085 base metal and weld. The open surface cracks are confirmed by examination of the welds' cross-sections shown in FIG. 5.

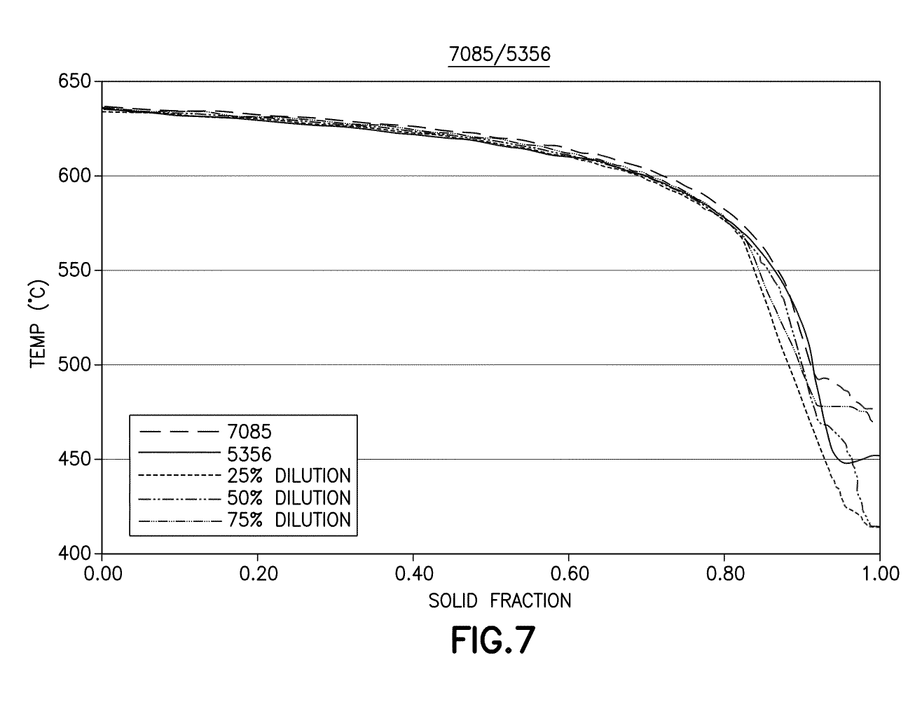

FIG. 7 is a graph showing the solidification analysis of the AA5356 filler alloy for fusion welding AA7085 parts. Note how close, and at times intersecting, the solidus temperatures of resultant welds are at different percentages of AA7085 base metal dilution into the weld.

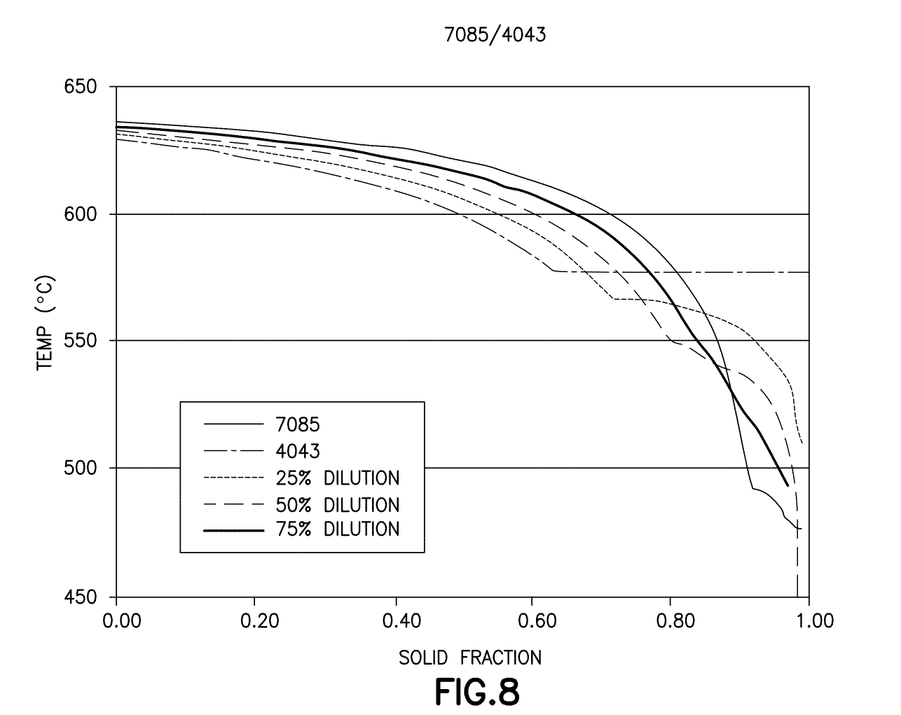

FIG. 8 is a graph showing the solidification analysis of the AA4043 filler alloy for fusion welding AA7085 parts. Note how close, and at times intersecting, the solidus temperature of resultant welds are at different percentages of 7085 base metal dilution into the weld.

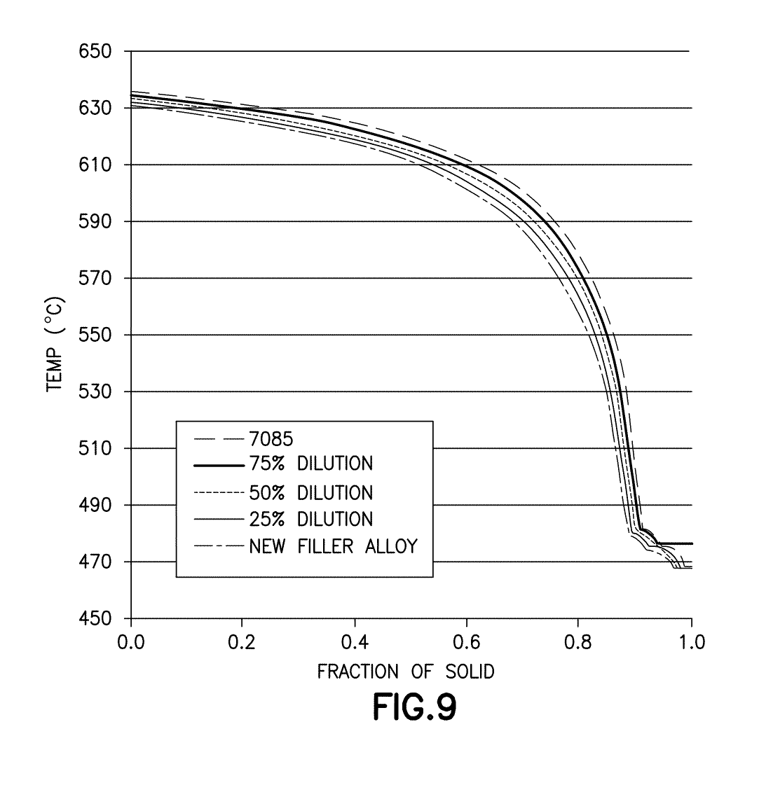

FIG. 9 is a graph showing the solidification analysis with the new filler alloy #266 filler alloy (Table 1) for fusion welding AA7085 parts. Note the solidus temperature of resultant welds at different percentages of AA7085 base metal dilution into the weld.

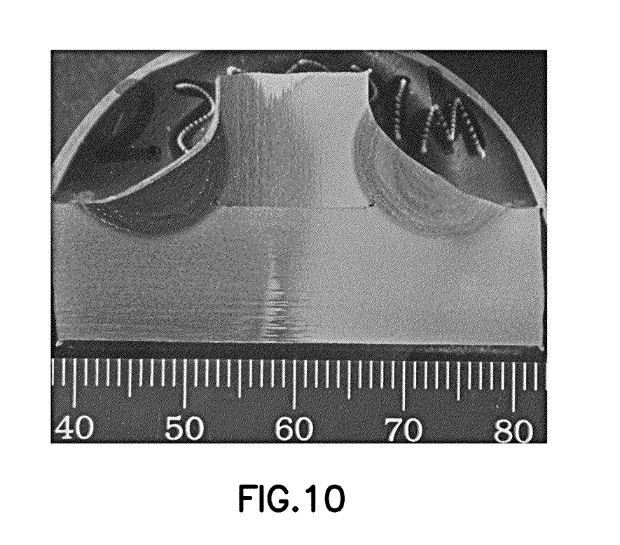

FIG. 10 shows a typical cross-sectional macrograph through a GTAW Tee-Double Fillet Weldment, used to assess the fusion weldability of different weld filler alloys for welding AA 7085 parts in this example.

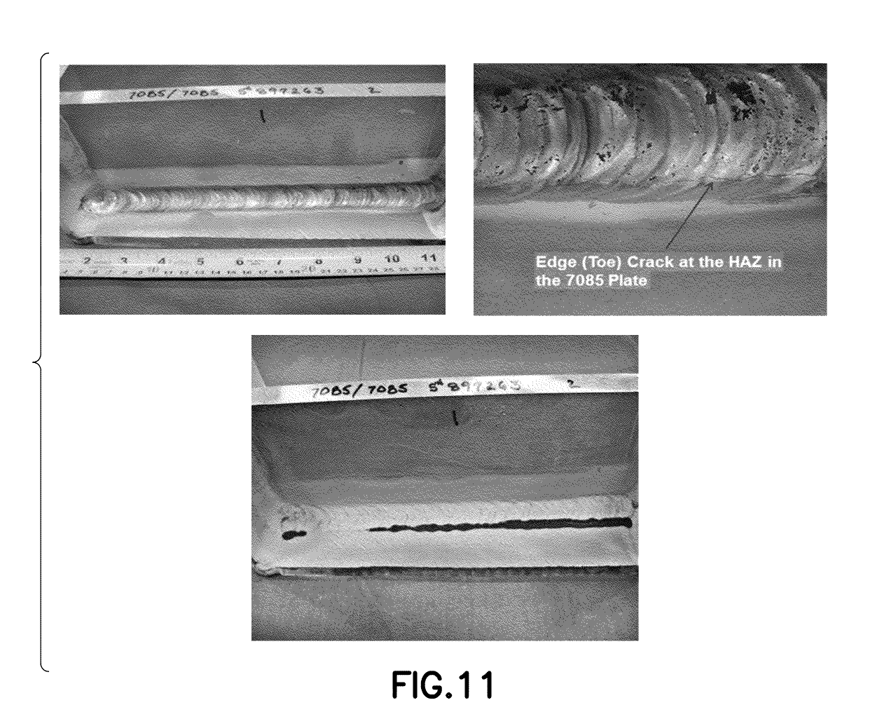

FIG. 11 includes three photographs of a weld of 7085 base metal with filler alloy #263. Dye penetrant can be seen in the bottom photograph. Note the edge (toe) cracks revealed with upon both visual and dye penetrant inspections.

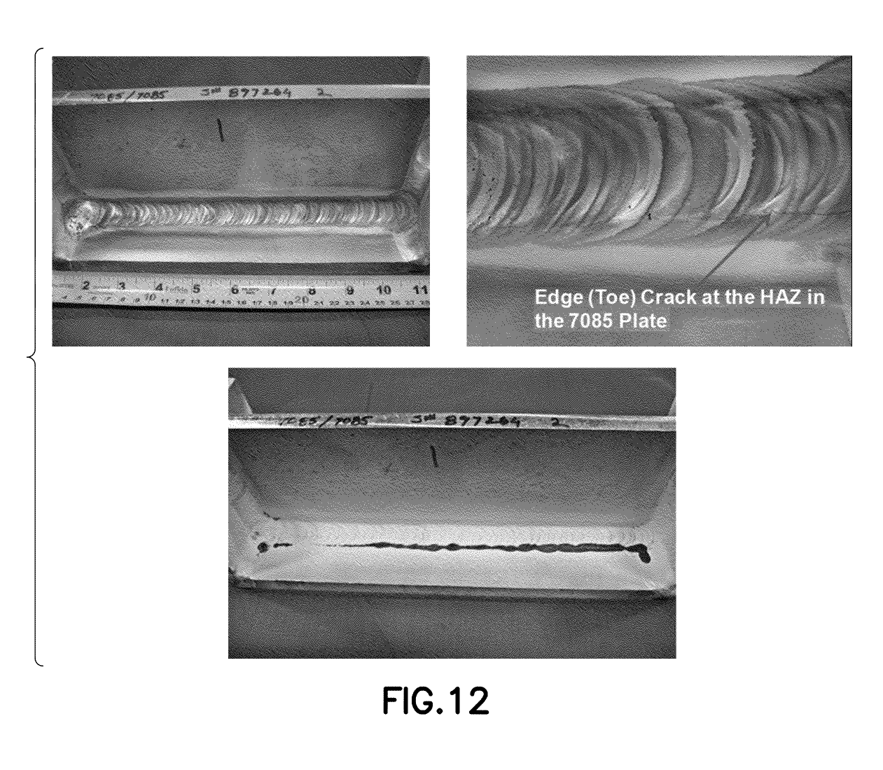

FIG. 12 includes three photographs of a weld of AA7085 base metal with filler alloy #264. Dye penetrant can be seen in the bottom photograph. Note the edge (toe) cracks revealed with upon both visual and dye penetrant inspections.

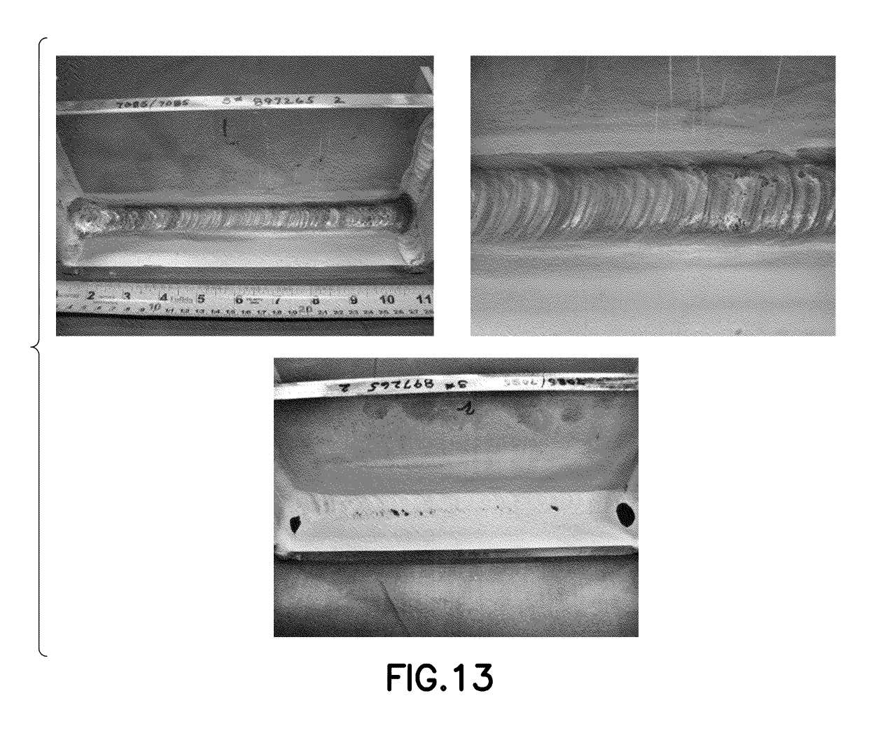

FIG. 13 includes three photographs of a weld of AA7085 base metal with filler alloy #265. Besides some small surface-breaking openings, consisting of small pores and contaminants, these inspections showed no major weld and/or HAZ cracks.

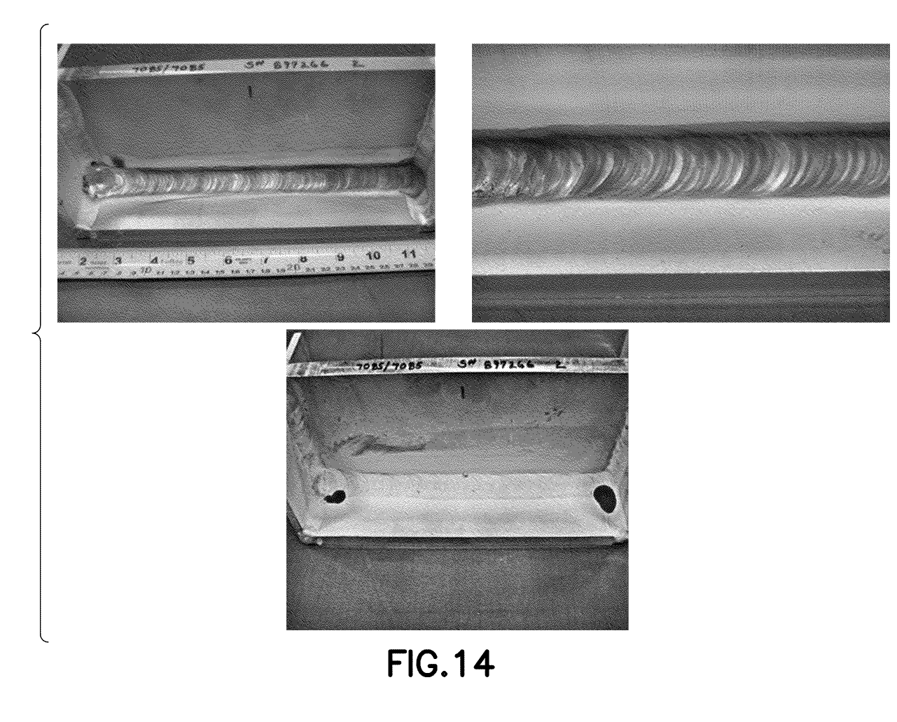

FIG. 14 includes three photographs of a weld of AA7085 base metal with filler alloy #266. Note that this weld did not show open pores and/or cracks.

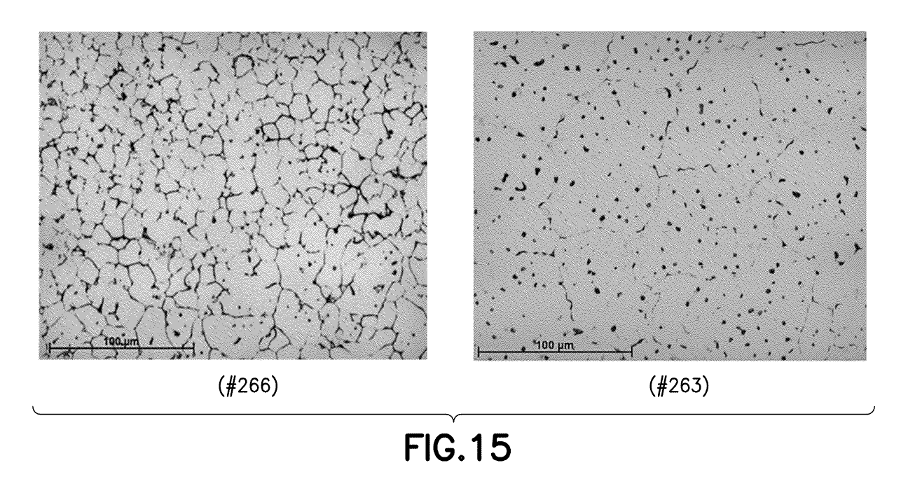

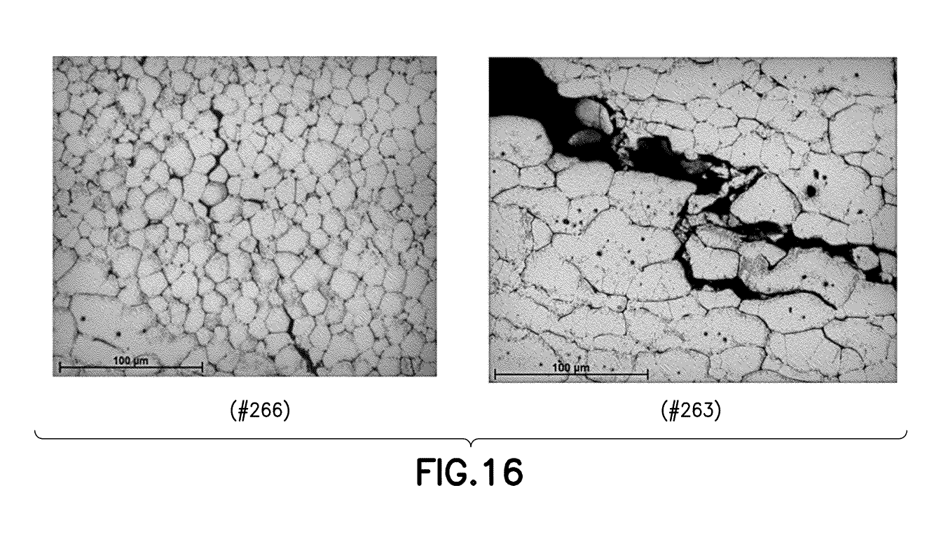

FIG. 15 is a comparison of cross-sectional optical micrographs (320×) through double-fillet welds showing the pronounced difference between welds produced with alloy #266 and filler alloy #263 (Table 1). Note how significantly finer (i.e. smaller grains) the weld produced with welding filler alloy #266 is as compared to the weld produced with the alternate filler alloy #263. The main difference between the two alloys is the addition of 0.3% (by weight) of scandium to (#266), which augments the grain refining achieved by TiBor. This difference in the micro-structures between the welds in conjunction with the lower solidus temperature of the welds produced with the filler alloy #266, in comparison to the solidus temperatures of the fusion-zones and heat affected zones adjacent to the weld, leads to a significant reduction in the propensity to cracking of the welds, as they solidify, and hot-cracking in the regions adjacent to these welds.

As can be seen when comparing the micrographs shown in FIG. 12, even when cracks develop in the welds produced with filler alloy #266, which contains 0.3% (by weight) of scandium, they are much finer (i.e. narrower and shorter) than the cracks formed in welds produced with scandium-free filler alloy #263.

The feasibility of fusion welding AA 7085 plates with an embodiment of a filler alloy has been successfully demonstrated. The fusion weldability of AA 7085 plates with the filler alloy #266 is compared with the fusion weldability of 7085 with the 5356 commercially available filler alloy and three other filler alloys (#263, #264, #265) (Table 3). Both visual and Dye-Penetrant inspections of all the welds, which were deposited with the manual (GTAW)(TIG) process, clearly demonstrated that the filler alloy (#266) yielded the soundest welds. The results with this weldability test were replicated three (3) times with each of the welding filler alloys.

### EXAMPLE 2

In example 2, post weld heat treatment of AA7085 base metal welded with filler metal according to certain embodiments was investigated.

TABLE 4
Composition limits of two candidate filler alloys

| Filler Aloy | Fe | Si | Mg | Cu | Zn | Zr | Sc | B* |
|---|---|---|---|---|---|---|---|---|
| C065D | <0.08 | <0.06 | 2.5 | 1.6 | 7.5 | 0.11 | 0 | 0.02 |
| C066D | <0.08 | <0.06 | 2.5 | 1.6 | 7.5 | 0.11 | 0.3 | 0.02 |

TABLE 5
Candidate Post Weld Heat Treatments
Post weld heat treatment investigation of 7085
plate welded with 7xxx + Sc filler wire

| | | | | # of |
|---|---|---|---|---|
| Condition | SHT | Quench | Aging | Specimens |
| 1 | log to 870 F. in 6 h | CWQ | 250 F./12 h + | 3 |
| | soak for 6 h, ramp to | | 310 F./9 h | |
| | 890 F. in 3 h and soak | | | |
| | for 12 h | | | |
| 2 | log to 890 F. in 6 h | CWQ | 250 F./12 h + | 3 |
| | and soak for 12 h | | 310 F./9 h | |
| 3 | log to 890 F. in 6 h | CWQ | 250 F./12 h + | 3 |
| | and soak for 6 h | | 310 F./9 h | |
| 4 | log to 890 F. in 6 h | force air | 250 F./12 h + | 3 |
| | and soak for 12 h | cool | 310 F./9 h | |
| 5 | log to 890 F. in 6 h | force air | 250 F./12 h + | 3 |
| | and soak for 6 h | cool | 310 F./9 h | |
| 6 | log to 890 F. in 6 h | air cool | 250 F./12 h + | 3 |
| | and soak for 12 h | | 310 F./9 h | |
| 7 | log to 890 F. in 6 h | CWQ | 375/20 min + | 3 |
| | and soak for 12 h | | 310 F./6 h | |
| 8 | log to 890 F. in 6 h | CWQ | 375/20 min + | 3 |
| | and soak for 12 h | | 320 F./4 h | |
| 9 | log to 890 F. in 6 h | force air | 310 F./9 h | 3 |
| | and soak for 12 h | cool | | |
| 10 | log to 890 F. in 6 h | force air | 310 F./9 h | 3 |
| | and soak for 6 h | cool | | |
| 11 | log to 890 F. in 6 h | force air | 375/20 min + | 3 |
| | and soak for 12 h | cool | 310 F./6 h | |
| 12 | log to 890 F. in 6 h | force air | 375/20 min + | 3 |
| | and soak for 6 h | cool | 320 F./4 h | |
| 13 | | | 250 F./12 h + | 3 |
| | | | 310 F./9 h | |
| 14 | | | 375/20 min + | 3 |
| | | | 310 F./6 h | |

TABLE 6
Weld efficiency after post weld heat treatment

| | | | T6 - Air | T6 - Forced | T6 - Water |
|---|---|---|---|---|---|
| Filler Alloy | As-welded | T5 | Cool | Air Cool | Quench |
| C065D | 46.3% | 49.7% | 77.7% | 86.4% | 98.1% |
| C066D | 53.7% | 60.0% | 79.5% | 85.2% | 98.2% |

### T5—Low Temperature Age

### T6—SHT+Quench+Age

Weld efficiency is defined as tensile strength of the weld divided by the tensile strength of the base metal.

Although the welding repair and mold plate repaired using the disclosed methods, systems and apparatus have been described in detail with reference to several embodiments, additional variations and modifications exist within the scope and spirit of the disclosure.

1. A method comprising:
a. fusion welding a filler metal to a first aluminum component;
i. wherein the first aluminum component comprises a 7xxx series aluminum alloy;
ii. wherein the filler metal comprises an aluminum alloy, in weight percent:
1. up to 0.15 Fe;
2. up to 0.15 Si;
3. from 2.3 to 2.7 Mg;
4. from 1.4 to 1.8 Cu;
5. from 6.0 to 9.0 Zn; and
6. from 0.06 to 0.14 Zr.

2. The method of claim 1 wherein the 7xxx series aluminum alloy comprises 0.5-2.6 wt. % Cu.

3. The method of claim 1 wherein the filler metal consists essentially of, in weight percent:
a. up to 0.15 Fe;
b. up to 0.15 Si;
c. from 2.3 to 2.7 Mg;
d. from 1.4 to 1.8 Cu;
e. from 6.0 to 9.0 Zn;
f. from 0.06 to 0.14 Zr; and
g. optionally, up to 0.45 Sc,
h. the remainder being aluminum, incidental elements and impurities.

4. The method of claim 1 wherein the filler metal comprises, in weight percent, up to 0.45 Sc.

5. The method of claim 1 wherein the filler metal comprises, in weight percent, 0.25-0.35 Sc.

6. The method of claim 1 wherein the filler metal comprises, in weight percent, up to 0.10 Fe.

7. The method of claim 1 wherein the filler metal comprises, in weight percent, up to 0.10 Si.

8. The method of claim 1 wherein the filler metal comprises, in weight percent, 7.3 to 7.7 Zn.

9. The method of claim 1 wherein the filler metal comprises, in weight percent, 0.10 to 0.12 Zr.

10. The method of claim 1 wherein the filler metal comprises, in weight percent, up to 0.03 B.

11. The method of claim 1 wherein the filler metal comprises, in weight percent, 0.015 to 0.025 B.

12. The method of claim 1 wherein the 7xxx series alloy comprises one of: 7x09, 7x10, 7x12, 7x14, 7x16, 7x20, 7x21, 7x22, 7x23, 7x24, 7x25, 7x26, 7x28, 7x29, 7x30, 7x32, 7x33, 7x34, 7x35, 7x36, 7x37, 7x40, 7x41, 7x42, 7046, 7x49, 7x50, 7x55, 7x56, 7x60, 7x64, 7x65, 7x68, 7x75, 7x76, 7x78, 7x79, 7x81, 7x85, 7x90, 7x93, 7x95 and 7x99.

13. The method of claim 12 wherein the 7xxx series alloy comprises one of: 7x09, 7x10, 7x12, 7x14, 7x16, 7x22, 7x23, 7x24, 7x25, 7x26, 7x29, 7x32, 7x33, 7x34, 7x36, 7x37, 7x40, 7x41, 7x42, 7x49, 7x50, 7x55, 7x56, 7x60, 7x64, 7x65, 7x68, 7x75, 7x76, 7x78, 7x79, 7x81, 7x85, 7x90, 7x93, 7x95 and 7x99.

14. The method of claim 1 wherein the 7xxx series alloy comprises, in weight percent:
a. up to 0.06 Si;
b. up to 0.08 Fe;
c. 1.3 to 2.0 Cu;
d. up to 0.04 Mn;
e. 1.2 to 1.8 Mg;
f. up to 0.04 Cr;
g. 7.0 to 8.0 Zn;
h. up to 0.15 Ti; and
i. 0.08 to 00.15 Zr.

15. A method comprising:
a. abutting a first aluminum component against a second aluminum component, wherein an abutment is formed, and
b. fusion welding a filler metal to the first aluminum component and to the second aluminum component so that a welded joint is formed at the abutment;
i. wherein the first aluminum component comprises a 7xxx series alloy;
ii. wherein the filler metal is an aluminum alloy comprising, in weight percent:
1. up to 0.15 Fe;
2. up to 0.15 Si;
3. from 2.3 to 2.7 Mg;
4. from 1.4 to 1.8 Cu;
5. from 6.0 to 9.0 Zn; and
6. from 0.06 to 0.14 Zr.

16. The method of claim 15 wherein the filler metal comprises, in weight percent, up to 0.45 Sc.

17. The method of claim 15 wherein the 7xxx series alloy comprises 0.5-2.6 wt. % Cu.

18. The method of claim 15 wherein the welded joint is one of a: butt, corner, edge, lap, and tee.

19. A method comprising:
a. locating a surface defect of a mold block;
i. wherein the surface defect has a first volume;
ii. wherein the surface defect is at least partially surrounded by an original volume;
iii. wherein the mold block includes the original volume;
iv. wherein the mold block is made of an aluminum alloy; and
b. wherein the aluminum alloy is a lox series aluminum alloy;
c. repairing the surface defect, wherein the repairing comprises fusion welding a filler metal to at least a portion of the original volume to produce a repaired volume;
i. wherein the repaired volume includes the first volume of the surface defect and at least a portion of the original volume; and
ii. wherein the filler metal is an aluminum alloy comprising, in weight percent:
1. up to 0.15 Fe;
2. up to 0.15 Si;
3. from 2.3 to 2.7 Mg;
4. from 1.4 to 1.8 Cu;
5. from 6.0 to 9.0 Zn; and
6. from 0.06 to 0.14 Zr.

20. The method of claim 19 wherein the filler metal comprises, in weight percent, up to 0.45 Sc.

21. The method of claim 19 wherein the 7xxx series aluminum alloy comprises0.5-2.6 wt. % Cu.
